(19) United States
(12) Patent Application Publication
(10) Pub. No.: US 2019/0155864 A1
(43) Pub. Date: May 23, 2019

(54) METHOD AND APPARATUS FOR RECOMMENDING BUSINESS OBJECT, ELECTRONIC DEVICE, AND STORAGE MEDIUM

(71) Applicant: BEIJING SENSETIME TECHNOLOGY DEVELOPMENT CO., LTD, Beijing (CN)

(72) Inventors: Binxu PENG, Beijing (CN); Lingyun KONG, Beijing (CN); Pingzhou YUAN, Beijing (CN)

(73) Assignee: BEIJING SENSETIME TECHNOLOGY DEVELOPMENT CO., LTD, Beijing (CN)

(21) Appl. No.: 16/314,402

(22) PCT Filed: May 22, 2018
(86) PCT No.: PCT/CN2018/087813

§ 371 Date: Dec. 29, 2018

(30) Foreign Application Priority Data
May 22, 2017 (CN) 201710364917.3

(51) Int. Cl. G06F 16/9535; G06Q 30/02

(52) U.S. Cl. CPC G06F 16/9535; G06Q 30/0245; G06Q 30/0201

(57) ABSTRACT

A method and an apparatus for recommending a business object, an electronic device, and a storage medium include: obtaining audience attribute information and business object attribute information; determining whether to display the business object according to the audience attribute information and the business object attribute information; and displaying, when determining to display the business object, the business object. By means of audience attribute information, a business object matching the audience can be determined from a business object library, and the business object is more in line with viewing interests of the audience; moreover, different business objects can be pushed to different audiences, so that the correctness and flexibility for pushing business objects are improved.

### CROSS-REFERENCE TO RELATED APPLICATION

The present application claims priority to Chinese Patent Application No. 201710364917.3, filed with the China Patent Office on May 22, 2017 and entitled “METHOD AND APPARATUS FOR RECOMMENDING BUSINESS OBJECT, ELECTRONIC DEVICES, AND STORAGE MEDIUM,” the disclosure of which is hereby incorporated by reference in its entirety.

### TECHNICAL FIELD

Embodiments of the present disclosure relate to the technical field of data processing, and in particular, to a method and an apparatus for recommending a business object, an electronic device, and a storage medium.

### BACKGROUND

At present, in the Internet, attribute data of users plays an increasingly important role in the field of advertisements, and the attribute data of users can guide the investment of advertisements.

In existing analysis schemes of user attribute data, users are mainly tagged through historical behavior data of the users, such as a browser cookie, and then the users are classified by means of the tags, so as to obtain the attribute data of the users.

### SUMMARY

Embodiments of the present disclosure provide a method and an apparatus for recommending a business object, an electronic device, and a storage medium.

According to a first aspect of the embodiments of the present disclosure, a method for recommending a business object is provided, and includes: obtaining audience attribute information and business object attribute information; determining whether to display the business object according to the audience attribute information and the business object attribute information; and displaying, when determining to display the business object, the business object.

In one or more embodiments of the present disclosure, the determining whether to display the business object according to the audience attribute information and the business object attribute information includes: generating an audience tag vector according to the audience attribute information; generating a business object tag vector according to the business object attribute information; determining an activation rate of the business object based on the audience tag vector and the business object tag vector; and determining, when the activation rate of the business object is greater than a set threshold, to display the business object.

In one or more embodiments of the present disclosure, the generating an audience tag vector according to the audience attribute information includes: generating tag values corresponding to audience attributes according to the audience attribute information; and generating the audience tag vector based on the tag values corresponding to the audience attributes.

In one or more embodiments of the present disclosure, the generating a business effect tag vector according to the business object attribute information includes: generating tag values corresponding to business effect attributes according to the business object attribute information; and generating the business effect tag vector based on the tag values corresponding to the business effect attributes.

In one or more embodiments of the present disclosure, the determining the activation rate of the business object based on the audience tag vector and the business object tag vector includes: determining the activation rate of the business object based on the audience tag vector and the business object tag vector by means of a logistic regression base model.

In one or more embodiments of the present disclosure, the determining the activation rate of the business object based on the audience tag vector and the business object tag vector by means of a logistic regression base model includes: determining the activation rate of the business object according to

p(h>0|a, u)=σ((2h−1)ωTx(a, u))=(1+e^{-(2h-1)ωTx(a,u)})⁻¹,

where p is the activation rate of the business object, u represents the audience tag vector, a represents the business object tag vector, x(a, u) represents a feature vector obtained by combining the audience tag vector and the business object tag vector, ω is the weighting coefficient of the audience attribute information and the business object attribute information, (2h−1)ωTx is a linear function, the output of (2h−1)ωTx is mapped to an interval (0, 1) through an S-type Sigmoid function σ(z)=(1+e^{-z})⁻¹, and (2h-1) is a click variable transformed to a set {−1, 1}.

In one or more embodiments of the present disclosure, the determining an activation rate of the business object based on the audience tag vector and the business object tag vector includes: obtaining an audience weight value and a business object weight value; weighting the audience tag vector and the business object tag vector respectively based on the audience weight value and the business object weight value; and determining the activation rate of the business object based on the weighted audience tag vector and business object tag vector.

In one or more embodiments of the present disclosure, the method further includes: regularizing the activation rate of the business object to obtain an optimal activation rate of the business object.

In one or more embodiments of the present disclosure, the displaying, when determining to display the business object, the business object includes: sorting, when it is determined that multiple business objects are displayed, the multiple business objects according to the activation rates of the multiple business objects; and displaying the business objects in sequential order.

In one or more embodiments of the present disclosure, the audience attribute information includes at least one of: basic attributes, physical features, purchase types, short-term attributes, behavior features, psychological features, live broadcast types of videos of interest, real-time state features or video commercial attributes of an audience.

In one or more embodiments of the present disclosure, the audience attribute information further includes: followed anchor attribute information; and the followed anchor attribute information includes at least one of: the talent type of the followed anchor, or the gender ratio and age ratio of a fan group having followed the anchor.

In one or more embodiments of the present disclosure, the business object attribute information includes at least one of: field, brand, effect attributes, trigger information, audience attributes or anchor attributes of the business object.

In one or more embodiments of the present disclosure, the business object includes: special effects containing advertising information.

According to a second aspect of the embodiments of the present disclosure, an apparatus for recommending a business object is further provided, and includes: an obtaining module, configured to obtain audience attribute information and business object attribute information; a determining module, configured to determine whether to display the business object according to the audience attribute information and the business object attribute information; and a display module, configured to display, when determining to display the business object, the business object.

In one or more embodiments of the present disclosure, the determining module includes: an audience tag vector generation sub-module, configured to generate an audience tag vector according to the audience attribute information; a business object tag vector generation sub-module, configured to generate a business object tag vector according to the business object attribute information; an activation rate determining sub-module, configured to determine an activation rate of the business object based on the audience tag vector and the business object tag vector; and a business object determining sub-module, configured to determine, when the activation rate of the business object is greater than a set threshold, to display the business object.

In one or more embodiments of the present disclosure, the audience tag vector generation sub-module is configured to generate tag values corresponding to audience attributes according to the audience attribute information, and generate the audience tag vector based on the tag values corresponding to the audience attributes.

In one or more embodiments of the present disclosure, the business object tag vector generation sub-module is configured to generate tag values corresponding to business object attributes according to the business object attribute information, and generate the business object tag vector based on the tag values corresponding to the business object attributes.

In one or more embodiments of the present disclosure, the activation rate determining sub-module is configured to determine the activation rate of the business object based on the audience tag vector and the business object tag vector by means of a logistic regression base model.

In one or more embodiments of the present disclosure, the activation rate determining sub-module is configured to determine the activation rate of the business object according to

p(h>0|a, u)=σ((2h−1)ωTx(a, u)=(1+e^{-(2h-1)ωTx(a,u)})⁻¹,

where p is the activation rate of the business object, u represents the audience tag vector, a represents the business object tag vector, x(a, u) represents a feature vector obtained by combining the audience tag vector and the business object tag vector, ω is the weighting coefficient of the audience attribute information and the business object attribute information, (2h−1)ωTx is a linear function, the output of (2h−1)ωTx is mapped to an interval (0, 1) through an S-type Sigmoid function σ(z)=(1+e^{-z})⁻¹, and (2h-1) is a click variable transformed to a set {−1, 1}.

In one or more embodiments of the present disclosure, the activation rate determining sub-module is configured to obtain an audience weight value and a business object weight value, weight the audience tag vector and the business object tag vector respectively based on the audience weight value and the business object weight value, and determine the activation rate of the business object based on the weighted audience tag vector and business object tag vector.

In one or more embodiments of the present disclosure, the apparatus further includes: a regularization module, configured to regularize the activation rate of the business object to obtain an optimal activation rate of the business object.

In one or more embodiments of the present disclosure, the display module includes: a sorting sub-module, configured to sort, when it is determined that multiple business objects are displayed, the multiple business objects according to the activation rates of the multiple business objects; and a display sub-module, configured to display the business objects in sequential order.

In one or more embodiments of the present disclosure, the audience attribute information includes at least one of: basic attributes, physical features, purchase types, short-term attributes, behavior features, psychological features, live broadcast types of videos of interest, real-time state features or video commercial attributes of an audience.

In one or more embodiments of the present disclosure, the audience attribute information further includes: followed anchor attribute information; and the followed anchor attribute information includes at least one of: the talent type of the followed anchor, or the gender ratio and age ratio of a fan group having followed the anchor.

In one or more embodiments of the present disclosure, the business object attribute information includes at least one of: field, brand, effect attributes, trigger information, audience attributes or anchor attributes of the business object.

In one or more embodiments of the present disclosure, the business object includes: special effects containing advertising information.

According to a third aspect of the embodiments of the present disclosure, an electronic device is further provided, and includes: a processor, a memory, a communication element, and a communication bus, where the processor, the memory, and the communication element communicate with one another by means of the communication bus; and the memory is configured to store at least one executable instruction, and the executable instruction causes the processor to execute corresponding operations of the method for recommending a business object according to the first aspect.

According to a fourth aspect of the embodiments of the present disclosure, a computer readable storage medium is further provided, and has a computer program stored thereon, where the program is executed by a processor to implement the steps of the method for recommending a business object according to the first aspect.

The technical solutions provided by the embodiments of the present disclosure may include the following beneficial effects:

By means of the method for recommending a business object in the embodiments of the present disclosure, audience attribute information and business object attribute information are obtained, whether to display the business object is determined according to the audience attribute information and the business object attribute information, and the business object is displayed when determining to display the business object. By means of the audience attribute information, a business object matching the audience can be determined from a business object library, and the business object is more in line with viewing interests of the audience; moreover, different business objects can be pushed to different audiences, so that the accuracy and flexibility for pushing business objects are improved.

It should be understood that the above general description and the following detailed description are merely exemplary and explanatory, and cannot limit the present disclosure.

### BRIEF DESCRIPTION OF DRAWINGS

The accompanying drawings constituting a part of the specification are used for describing embodiments of the present disclosure and are intended to explain the principles of the present disclosure together with the descriptions. According to the following detailed descriptions, the present disclosure can be understood more clearly with reference to the accompanying drawings.

FIG. 1 is a flowchart of steps of a method for recommending a business object provided by an embodiment of the present disclosure;

FIG. 2 is a flowchart of steps of a method for recommending a business object provided by another embodiment of the present disclosure;

FIG. 3 is a structure block diagram of an apparatus for recommending a business object provided by an embodiment of the present disclosure;

FIG. 4 is a structure block diagram of an apparatus for recommending a business object provided by another embodiment of the present disclosure; and

FIG. 5 is a schematic structural diagram of an electronic device provided by an embodiment of the present disclosure.

### DETAILED DESCRIPTION

The specific implementations of the embodiments of the present disclosure are further described in detail below with reference to the accompanying drawings (the same reference numerals in a plurality of accompanying drawings represent the same elements) and the embodiments. The following embodiments are intended to illustrate the embodiments of the present disclosure, but are not intended to limit the scope of the embodiments of the present disclosure.

Persons skilled in the art can understand that the terms “first”, “second” and the like in the embodiments of the present disclosure are only used to distinguish different steps, devices or modules, etc., and do not represent any specific technical meaning or inevitable logical sequence therebetween.

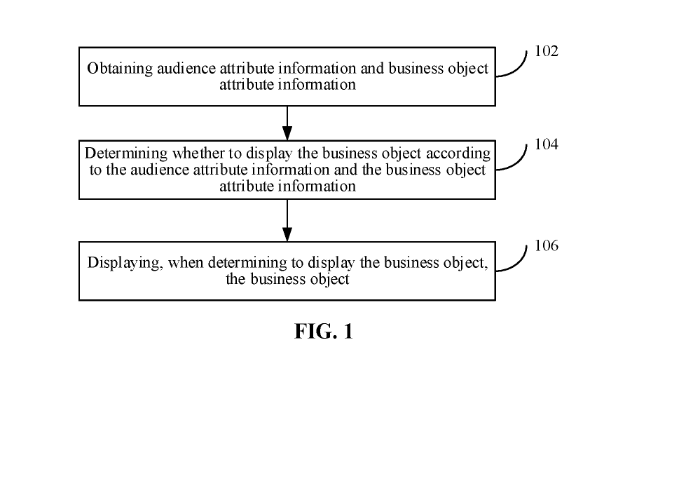

Referring to FIG. 1, a flowchart of steps of a method for recommending a business object provided by an embodiment of the present disclosure is shown.

In this embodiment, a background server in a live broadcast scenario is taken as an example to explain the method for recommending a business object in the embodiment of the present disclosure. It should be noted that the method for recommending a business object of this embodiment can be applied not only to the live broadcast scenario, but also to other scenarios, for example, application to a video on demand scenario. The method for recommending a business object of this embodiment may be executed at time nodes, such as before the video on demand or during a video on demand process. This embodiment does not limit the specific application scenarios of the method for recommending a business object. In the live broadcast scenario, the method provided by the embodiment of the present disclosure is applicable not only to the background server but also to a client, and no limitation is made in the embodiment of the present disclosure.

The method for recommending a business object of this embodiment may specifically include the following steps:

Step 102: audience attribute information and business object attribute information are obtained.

During application to a live broadcast scenario in the embodiment of the present disclosure, a first terminal (such as an anchor terminal) establishes a video communication connection with a second terminal (a fan terminal, i.e., an audience terminal) in a live broadcast room of a live broadcast platform where the video anchor is located through a background server. The background server, the first terminal, and the second terminal of this embodiment are all provided with a business object library, and the synchronization and update of business objects can be implemented through a network, where multiple types of business objects are stored in the business object library.

The background server obtains current audience attribute information, for example, obtaining the permission of a camera for the audience and collecting image data of the anchor by means of a camera, and then obtaining the audience attribute information through the image data, and for another example, obtaining the audience attribute information in the form of a questionnaire.

The attribute information of each business object in the business object library is obtained, for example, the business objects' attribute information is determined by means of conditional filtering; and then, the business objects' tag information corresponding to the business objects' attributes is determined according to the classification of the business objects' attribute information, where the tag information may be generated in the form of an entry in this embodiment.

The tag information of the anchor is established according to the obtained audience attribute information, for example, the tag information of the anchor is established according to the classification of the attribute information, where the tag information may be generated in the form of an entry in this embodiment.

Step 104: whether to display the business object is determined according to the audience attribute information and the business object attribute information.

In this embodiment, in order to determine business objects suitable for audience attributes and achieve the purpose of accurate recommendation, the audience attribute information and the business object attribute information are combined to determine whether a suitable business object exists, for example, the audience attribute information and the business object attribute information are taken as parameters to determine whether an business object matching the two parameters exists in the business object library.

Step 106: when determining to display the business object, the business object is displayed.

When the background server determines to display the business object, a series of related processing may be performed on one or more business objects to be displayed, and the processed business objects to be displayed are displayed on the second terminal.

In an optional implementation, for example, in a live broadcast scenario, after the anchor terminal receives the business objects to be displayed pushed by the background server, multiple business objects to be displayed may be displayed on a live broadcast interface of the anchor terminal in the form of a list, so that some business objects or all the business objects may be selected and pushed to audiences in the live broadcast room at the anchor terminal based on the list, and the business objects may also be sorted and then pushed to the audiences in the live broadcast room at the anchor terminal, thereby displaying the business objects pushed by the anchor terminal on audience terminals.

In the method for recommending a business object in this embodiment, the audience attribute information and the business object attribute information are obtained, whether to display the business object is determined according to the audience attribute information and the business object attribute information, and the business object is displayed when determining to display the business object. By means of the audience attribute information, a business object matching the audience can be determined from a business object library, and the business object is more in line with viewing interests of the audience; moreover, different business objects can be pushed to different audiences, so that the correctness and flexibility for pushing business objects are improved.

Based on the foregoing embodiments, this embodiment focuses on the differences from the foregoing embodiments. For the same points, reference may be made to the related descriptions in the foregoing embodiments, and details are not described herein again.

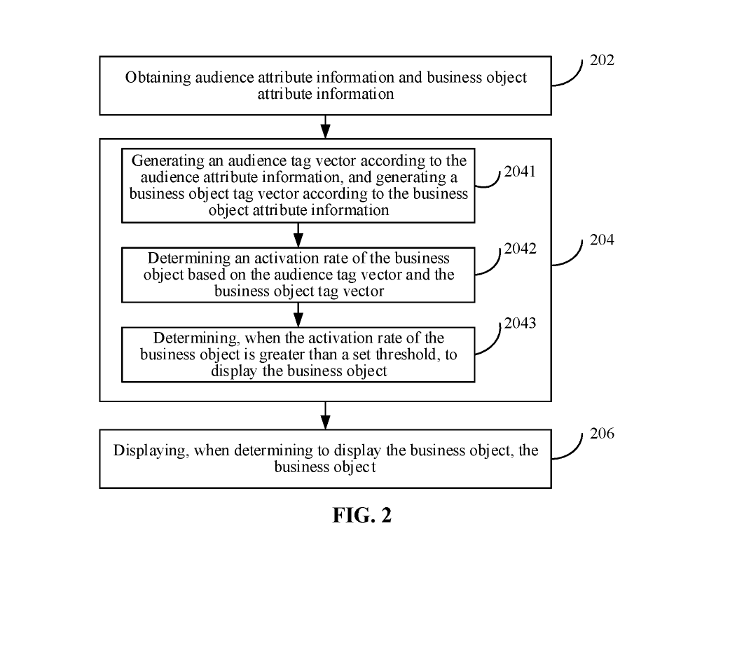

Referring to FIG. 2, a flowchart of steps of a method for recommending a business object provided by another embodiment of the present disclosure is shown.

Step 202: audience attribute information and business object attribute information are obtained.

Step 204: whether to display the business object is determined according to the audience attribute information and the business object attribute information.

In one or more embodiments of the present disclosure, step 204 may include the following sub-steps:

Sub-step 2041: an audience tag vector is generated according to the audience attribute information, and a business object tag vector is generated according to the business object attribute information.

In sub-step 2041, during the generation of the audience tag vector, tag values corresponding to audience attributes may be generated according to the audience attribute information; and the audience tag vector may be generated based on the tag values corresponding to the audience attributes.

In an optional implementation, before performing live broadcast by an anchor or during the live broadcast process, the background server obtains audience attribute information of the current anchor. The audience attribute information includes at least one of: basic attributes, physical features, purchase types, short-term attributes, behavior features, psychological features, live broadcast types of videos of interest, real-time state features or video commercial attributes of an audience. The audience attribute information further includes: followed anchor attribute information; and the followed anchor attribute information includes at least one of: the gender ratio and age ratio of a fan group having followed the anchor, or the talent type of the followed anchor. The tag values corresponding to audience attributes are generated according to the audience attribute information. Refer to Table 1 for the tag values corresponding to audience attributes.

TABLE 1

Basic attributes: gender, age, resident area, occupation,
education level, etc.
Physical features: height, weight, face value, wearing, etc.
Purchase types: income status, whether the audience owns a
car, whether the audience owns a house, shopping types, brand
preferences, etc.
Short-term attributes: whether the audience is pregnant,
whether the audience has a baby, whether the audience just
bought a house, and whether the audience just bought a car.
Behavior features: hobbies, skills in art (singing/dancing),
and active level.
Psychological features: emotional state (single/in love), and
personality traits (cheerful/quiet/intelligent).
Features of Followed anchor: gender ratio, age ratio, and
talent type of anchor.
Real-time state features of user: real-time location,
emoticons, real-time influence.
Video commercial attributes: attention to advertisements of the
live broadcast platform (high, intermediate, low), major
concerns on advertisement categories (fast food, cosmetics,
sports brands, etc.), etc.

In this embodiment, in order to make the processing workload of generating the audience tag vector relatively low, the tag values corresponding to the audience attributes can be binarized, i.e., in the tag values corresponding to the audience attributes, “yes” is represented by “1”, “no” is represented by “0”, and the audience tag vector is represented by u(n). Refer to Table 2.

TABLE 2

| | | Attribute | Vector |
|---|---|---|---|
| Categories | Attributes | values | values |
| Basic attributes | Gender | Male | 1 |
| | | Female | 0 |
| | Age | 0-12 years old | 0 |
| | | 13-20 years old | 0 |
| | | 21-35 years old | 1 |
| | | 36-50 years old | 0 |
| | | >50 years old | 0 |
| | . . . | — | — |
| Video commercial | Attention to | High | 0 |
| attributes | advertisements of | Intermediate | 1 |
| | the live broadcast | Low | 0 |
| | platform | | |
| | Major concerns on | Fast food | 1 |
| | advertisement | Cosmetics | 0 |
| | categories | Sports brands | 0 |
| Features of | Talents of anchor | Dancing | 0 |
| followed anchor | | Signing | 1 |
| | | Gaming | 1 |
| | | Talk-show | 0 |
| | | Trendsetter | 0 |
| | . . . | — | — |

In sub-step 2041, during the generation of the business object tag vector, tag values corresponding to business object attributes may be generated according to the business object attribute information; and the business object tag vector may be generated based on the tag values corresponding to the business object attributes.

In an optional implementation, the background server, the first terminal, and the second terminal of this embodiment are all provided with a business object library, and the synchronization and update of business objects can be implemented through a network, where the business objects include special effects containing advertising information, such as special effects containing advertising information in at least one of the following forms: two-dimensional sticker effects, three-dimensional effects, or particle effects. For example, an advertisement displayed in the form of a sticker (i.e., an advertisement sticker); or a specific effect for displaying an advertisement, such as a 3D advertisement effect. However, the special effects are not limited thereto. The business objects in other forms are also applicable to the method for recommending a business object provided by the embodiment of the present disclosure, such as the text description or introduction of an APP or other applications, or an object in a certain form that interacts with the audience (such as an electronic pet).

The business object attribute information includes at least one of: field, brand, effect attributes, trigger information, audience attributes or anchor attributes of the business object. The tag values corresponding to the business effect attributes are generated according to the business object attribute information. Refer to Table 3 for the tag values corresponding to the business effect attributes.

TABLE 3

Industry (i.e., fields): transportation, real estate, food and
beverage, network services, daily chemicals, financial services,
leisure and entertainment, IT products.
Brands: Uniqlo, General Motors, JDB, and Jiedaibao.
Effects: humorous, cute, cool, and others.
Trigger modes: palm, hand, loving heart, face, mouth, background,
and foreground.
Audience attributes: gender, age, region, operating system, and
network access mode.
Anchor attributes: gender, age, and the number of fans.

In this embodiment, in order to make the processing workload of generating the business object tag vector relatively low, the tag values corresponding to the business object attributes can be binarized, i.e., in the tag values corresponding to the business object attributes, “yes” is represented by “1”, “no” is represented by “0”, and the business object tag vector is represented by a(n). Refer to Table 4.

TABLE 4

| | | Attribute | Vector |
|---|---|---|---|
| Categories | Attributes | values | values |
| Business object | Industry | Transportation | 1 |
| information | | | |
| | | Food and | 0 |
| | | beverage | |
| | | Network | 0 |
| | | services | |
| | | — | 0 |
| | Effects | Humorous | 1 |
| | | Cute | 0 |
| | | Cool | 0 |
| | | Others | 0 |
| Audience | Gender | Male | 0 |
| attributes | | Female | 1 |
| | Age | 0-12 years old | 0 |
| | | 13-20 years old | 1 |
| | | 21-35 years old | 0 |
| | | 36-50 years old | 0 |
| | | >50 years old | 0 |

Sub-step 2042: an activation rate of the business object is determined based on the audience tag vector and the business object tag vector.

In sub-step 2042, the activation rate of the business object may be determined based on the audience tag vector and the business object tag vector by means of a logistic regression base model.

In an optional implementation, x(a, u) is used to represent a feature vector obtained by combining u(n) and a(n), and then a logistic regression base model is used to determine the activation rate of the business object. The following formula can be used:

p(h>0|a, u)=σ((2h−1)ωTx(a, u))=(1+e^{-(2h-1)ωTx(a,u)})⁻¹

where p is the activation rate of the business object, u represents the audience tag vector, a represents the business object tag vector, x(a, u) represents the feature vector obtained by combining the audience tag vector and the business object tag vector, ω is the weighting coefficient of the audience attribute information and the business object attribute information, and is also a parameter needing to be optimized by the logistic regression base model; the output of the linear function (2h−1)ωTx is mapped to an interval (0, 1) through an S-type Sigmoid function σ(z)=(1+e^{-z})⁻¹; (2h−1) is to transform a click variable in {0, 1, 2, 3, . . . , N} to a set {−1, 1}; if click variable h belongs to set {0, 1}, then (2h−1) belongs to set {−1, 1}, where h=0 represents no click, h=1 represents a transformation from set {0, 1} to set {−1, 1}. The goal is to make better use of the linear function (2h−1)ωTx, so as to accurately determine the activation rate of the business object.

In this embodiment, in order to more accurately calculate the activation rate, an audience weight value and a business object weight value may be obtained; the audience tag vector and the business object tag vector may be weighted respectively based on the audience weight value and the business object weight value; and the activation rate of the business object may be determined based on the weighted audience tag vector and business object tag vector. For example, if ω is the weighting coefficient of the attribute information (including the audience attribute information and the business object attribute information), the weighting coefficient of u(n) is 0.5, and the weighting coefficient of a(n) is 0.5.

In this embodiment, when calculating the activation rate of the business object, in order to reduce errors, the activation rate of the business object may be regularized to obtain an optimal activation rate of the business object. The following formula can be used:

$$min ( C {\sum }_{i = 1}^{T} ln ( 1 + {e}^{- ( 2 h - 1 ) wTx ( a , u )} ) + \frac{1}{2} wTw )$$

where C is a constant, which can represent the tolerance rate, and T represents the number of business objects.

Sub-step 2043: when the activation rate of the business object is greater than a set threshold, it is determined to display the business object.

In this embodiment, the set threshold is a, for example, a is 0.6; when the activation rate of the business object is greater than the set threshold a, business objects having an activation rate of greater than 0.6 are determined to be the business objects to be displayed, and the threshold value a can be set according to the average value of the activation rates of all the business objects. No specific limitation is made thereto in this embodiment.

Step 206: when determining to display the business object, the business object is displayed.

In this embodiment, one or more business objects may be displayed; when it is determined that multiple business objects are displayed, the multiple business objects may be sorted according to the activation rates of the multiple business objects, for example, the multiple business objects are sorted according to the activation rates of the multiple business objects from high to low, and then the multiple business objects are displayed in sequential order.

Furthermore, in this embodiment, in order to prevent the number of the displayed business objects from being too large, it is also possible to set an upper limit of the number of the displayed business objects, for example, setting the number of the displayed business objects to not more than 20.

It should be noted that the steps of sorting the multiple business objects in this embodiment may be completed in the background server first, and then the sorted business objects to be displayed are pushed to the first terminal; and the determined business objects to be displayed may also be first pushed to the first terminal, and then are sorted by the anchor by means of the first terminal. In this regard, no specific limitation is made in this embodiment.

In the method for recommending a business object of this embodiment, audience attribute information and business object attribute information are obtained; an audience tag vector is generated according to the audience attribute information; a business object tag vector is generated according to the business object attribute information; an activation rate of the business object is determined based on the audience tag vector and the business object tag vector; business objects having an activation rate of greater than the set threshold are determined as business objects to be displayed; and if there are multiple business objects to be displayed, the multiple business objects are sorted according to the activation rates of the multiple business objects, and the business objects are displayed according to the sorting. By means of the audience attribute information, a business object matching the audience can be determined from a business object library, and the business object is more in line with viewing interests of the audience; moreover, different business objects can be pushed to different audiences, so that the improvements to the correctness and flexibility for pushing business objects are facilitated.

In this embodiment, the tag values corresponding to the audience attributes and the tag values corresponding to the business object attributes are binarized, thereby reducing the workload of generating the audience tag vector and the business object tag vector.

In this embodiment, the audience tag vector and the business object tag vector are respectively weighted according to the audience weight value and the business object weight value, and then the activation rate of the business object is determined based on the weighted audience tag vector and business object tag vector, thereby facilitating improving the calculation precision of the activation rate of the business object, and thus facilitating making the activation rate of the business object more accurate.

In this embodiment, the activation rate of the business object is regularized to obtain an optimal activation rate, thereby facilitating reducing the calculation error of the activation rate of the business object.

Persons skilled in the art can understand that, in the foregoing method according to the specific implementations in the embodiments of the present disclosure, the serial numbers of the steps do not mean the sequence of executing the steps, and the sequence of executing the steps should be determined according to functions and internal logics thereof, but should not be any limitation to the implementation process of the specific implementations in the embodiments of the present disclosure.

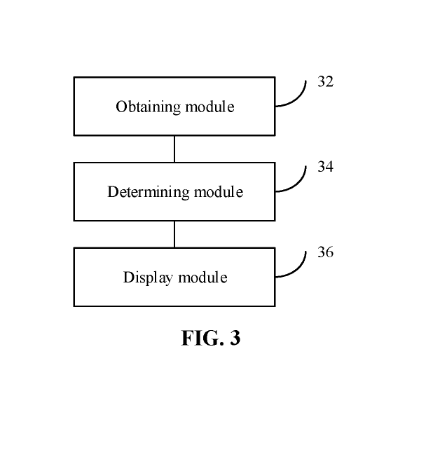

Referring to FIG. 3, a structure block diagram of an apparatus for recommending a business object provided by an embodiment of the present disclosure is shown. The apparatus may include the following modules: an obtaining module 32, configured to obtain audience attribute information and business object attribute information; a determining module 34, configured to determine whether to display the business object according to the audience attribute information and the business object attribute information; and a display module 36, configured to display, when determining to display the business object, the business object.

In the apparatus for recommending a business object in this embodiment, the audience attribute information and the business object attribute information are obtained, whether to display the business object is determined according to the audience attribute information and the business object attribute information, and the business object is displayed when determining to display the business object. By means of the audience attribute information, a business object matching the audience can be determined from a business object library, and the business object is more in line with viewing interests of the audience; moreover, different business objects can be pushed to different audiences, so that the improvements to the correctness and flexibility for pushing business objects are facilitated.

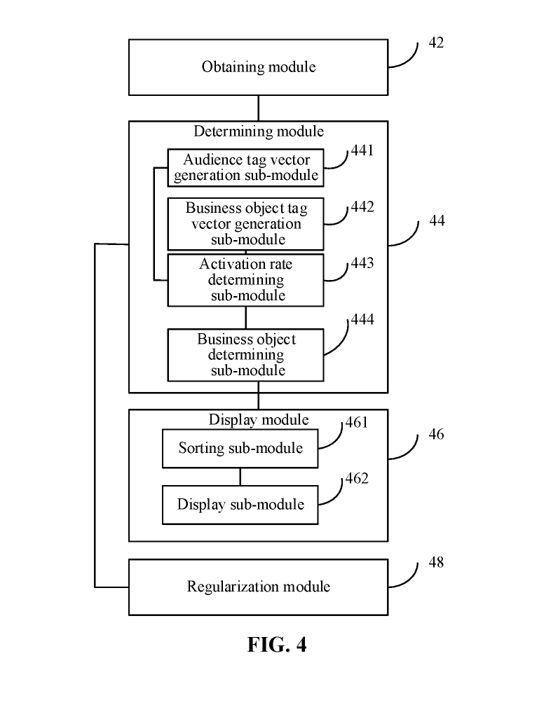

Referring to FIG. 4, a structure block diagram of an apparatus for recommending a business object provided by another embodiment of the present disclosure is shown. The apparatus may include the following modules: an obtaining module 42, configured to obtain audience attribute information and business object attribute information; a determining module 44, configured to determine whether to display the business object according to the audience attribute information and the business object attribute information; and a display module 46, configured to display, when determining to display the business object, the business object.

In one or more embodiments of the present disclosure, the determining module 44 includes: an audience tag vector generation sub-module 441, configured to generate an audience tag vector according to the audience attribute information; a business object tag vector generation sub-module 442, configured to generate a business object tag vector according to the business object attribute information; an activation rate determining sub-module 443, configured to determine an activation rate of the business object based on the audience tag vector and the business object tag vector; and a business object determining sub-module 444, configured to determine, when the activation rate of the business object is greater than a set threshold, to display the business object.

In one or more embodiments of the present disclosure, the audience tag vector generation sub-module 441 is configured to generate tag values corresponding to audience attributes according to the audience attribute information, and generate the audience tag vector based on the tag values corresponding to the audience attributes.

In one or more embodiments of the present disclosure, the business object tag vector generation sub-module 442 is configured to generate tag values corresponding to business object attributes according to the business object attribute information, and generate the business object tag vector based on the tag values corresponding to the business object attributes.

In one or more embodiments of the present disclosure, the activation rate determining sub-module 443 is configured to determine the activation rate of the business object based on the audience tag vector and the business object tag vector by means of a logistic regression base model.

In one or more embodiments of the present disclosure, the activation rate determining sub-module 443 is configured to determine the activation rate of the business object according to

p(h>0|a, u)=σ((2h−1)ωTx(a, u))=(1+e^{-(2h-1)ωTx(a,u)})⁻¹,

where p is the activation rate of the business object, u represents the audience tag vector, a represents the business object tag vector, x(a, u) represents a feature vector obtained by combining the audience tag vector and the business object tag vector, ω is the weighting coefficient of the audience attribute information and the business object attribute information, (2h−1)ωTx is a linear function, the output of (2h−1)ωTx is mapped to an interval (0, 1) through an S-type Sigmoid function σ(z)=(1+e⁻¹)⁻¹, and (2h−1) is a click variable transformed to a set {−1, 1}.

In one or more embodiments of the present disclosure, the activation rate determining sub-module 443 is configured to obtain an audience weight value and a business object weight value, weight the audience tag vector and the business object tag vector respectively based on the audience weight value and the business object weight value, and determine the activation rate of the business object based on the weighted audience tag vector and business object tag vector.

In one or more embodiments of the present disclosure, the apparatus for recommending a business object further includes: a regularization module 48, configured to regularize the activation rate of the business object to obtain an optimal activation rate of the business object.

In one or more embodiments of the present disclosure, the display module 46 includes: a sorting sub-module 461, configured to sort, when it is determined that multiple business objects are displayed, the multiple business objects according to the activation rates of the multiple business objects; and a display sub-module 462, configured to display the business objects in sequential order.

In one or more embodiments of the present disclosure, the audience attribute information includes at least one of: basic attributes, physical features, purchase types, short-term attributes, behavior features, psychological features, live broadcast types of videos of interest, real-time state features or video commercial attributes of an audience.

In one or more embodiments of the present disclosure, the audience attribute information further includes: followed anchor attribute information; and the followed anchor attribute information includes at least one of: the talent type of the followed anchor, or the gender ratio and age ratio of a fan group having followed the anchor.

In one or more embodiments of the present disclosure, the business object attribute information includes at least one of: field, brand, effect attributes, trigger information, audience attributes or anchor attributes of the business object.

In one or more embodiments of the present disclosure, the business object includes: special effects containing advertising information.

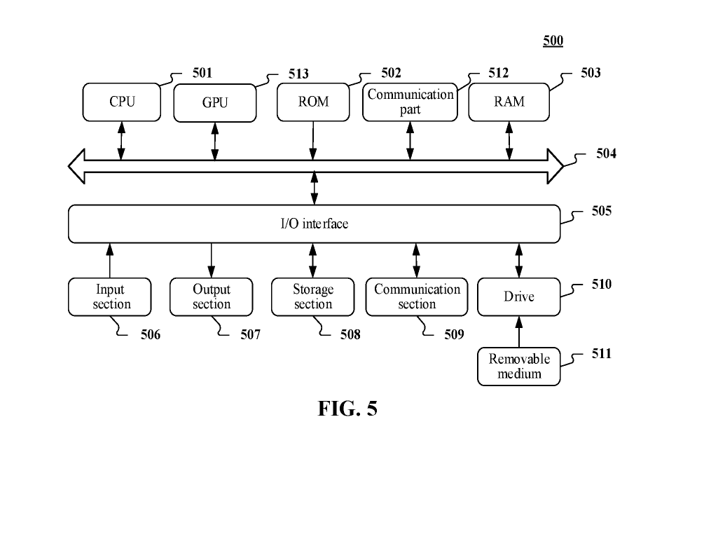

The embodiments of the present disclosure further provide an electronic device which, for example, may be a mobile terminal, a Personal Computer (PC), a tablet computer, a server, and the like. Referring to FIG. 5 below, a schematic structural diagram of an electronic device 500 suitable for implementing the apparatus for recommending a business object provided by an embodiment of the present disclosure is shown. As shown in FIG. 5, the electronic device 500 includes one or more processors, a communication element, and the like. The one or more processors are, for example, one or more Central Processing Units (CPUs) 501 and/or one or more Graphic Processing Units (GPUs) 513, and the processors may execute appropriate actions and processing according to executable instructions stored in a Read-Only Memory (ROM) 502 or executable instructions loaded from a storage section 508 to a Random Access Memory (RAM) 503. The communication element includes a communication part 512 and/or a communication section (such as a communication interface) 509. The communication part 512 may include, but is not limited to, a network card. The network card may include, but is not limited to, an InfiniBand (IB) network card. The communication section 509 includes a communication interface of a network interface card such as a LAN card and a modem, and the communication section 509 performs communication processing via a network such as the Internet.

The processor may communicate with the ROM 502 and/or the RAM 503 to execute the executable instructions, be connected to the communication part 512 by means of a communication bus 504, and communicate with other target devices via the communication part 512, thereby completing corresponding operations of the method for recommending a business object provided by any one of the embodiments of the present disclosure, such as, obtaining audience attribute information and business object attribute information; determining whether to display the business object according to the audience attribute information and the business object attribute information; and displaying, when determining to display the business object, the business object.

Furthermore, in the RAM 503, programs and data required for the operations of the apparatus may further be stored. The CPU 501 or GPU 513, the ROM 502, and the RAM 503 are connected to each other by means of the communication bus 504. In the presence of the RAM 503, the ROM 502 is an optional module. The RAM 503 stores executable instructions, or writes the executable instructions to the ROM 502 during running; the executable instructions cause the processor to execute corresponding operations of the foregoing communication method. An Input/output (I/O) interface 505 is also connected to the communication bus 504. The communication part 512 may be an integrated, or may be configured to have multiple sub-modules (such as, multiple IB network cards), and is linked with the communication bus.

The following components are connected to the I/O interface 505: an input section 506 including a keyboard, a mouse and the like; an output section 507 including a Cathode-Ray Tube (CRT), a Liquid Crystal Display (LCD), a loudspeaker and the like; a storage section 508 including hardware and the like; and a communication interface 509 of a network interface card such as a LAN card and a modem. A drive 510 is also connected to the I/O interface 505 according to needs. A removable medium 511 such as a magnetic disk, an optical disk, a magneto-optical disk, a semiconductor memory or the like is mounted on the drive 510 according to needs, so that a computer program read from the removable medium 511 may be installed on the storage section 508 according to needs.

It should be noted that, the architecture shown in FIG. 5 is merely an optional implementation. During specific practice, a number and types of the components in FIG. 5 may be selected, decreased, increased, or replaced according to actual needs. Different functional components may be separated or integrated or the like. For example, the GPU 513 and the CPU 501 may be separated, or the GPU 513 may be integrated on the CPU 501, and the communication element may be separated from or integrated on the CPU 501 or the GPU 513 or the like. These alternative implementations all fall within the scope of protection of the present disclosure.

According to the embodiments of the present disclosure, the process described above with reference to the flowchart may be implemented as a computer readable storage medium having a computer program stored thereon, and the steps of implementing the method for recommending a business object in the foregoing embodiments are implemented when the program is executed by the processor. For example, the embodiment of the present disclosure includes a computer program product, including a computer program tangibly included in a machine-readable medium. The computer program includes a program code for executing the method shown in the flowchart. The program code may include instructions for correspondingly executing corresponding steps of the method provided by the embodiment of the present disclosure, for example, obtaining audience attribute information and business object attribute information; determining whether to display the business object according to the audience attribute information and the business object attribute information; and displaying, when determining to display the business object, the business object. In such an embodiment, the computer program may be downloaded and installed from the network by means of the communication element, and/or may be installed from the removable medium 511. When executed by the processor, the computer program executes the foregoing functions defined in the method of the embodiment of the present disclosure.

The methods and apparatuses, and the devices of the present disclosure may be implemented in many manners. For example, the methods and apparatuses, and the devices in the embodiments of the present disclosure may be implemented by using software, hardware, firmware, or any combination of software, hardware, and firmware. Unless otherwise specially stated, the foregoing sequences of steps of the methods are merely for description, and are not intended to limit the steps of the methods of the present disclosure. In addition, in some embodiments, the present disclosure may be implemented as programs recorded in a recording medium. The programs include machine-readable instructions for implementing the methods according to the embodiments of the present disclosure. Therefore, the present disclosure further covers the recording medium storing the program for executing the methods in the embodiments of the present disclosure.

The descriptions of the embodiments of the present disclosure are provided for the purpose of examples and description, and are not intended to be exhaustive or limit the present disclosure to the disclosed form. Many modifications and changes are obvious to persons of ordinary skill in the art. The embodiments are selected and described to better describe the principles and actual applications of the present disclosure, and to make persons of ordinary skill in the art understand the present disclosure, so as to design various embodiments with various modifications applicable to particular use.

1. A method for recommending a business object, comprising:
obtaining audience attribute information and business object attribute information;
determining whether to display the business object according to the audience attribute information and the business object attribute information; and
displaying, when determining to display the business object, the business object.

2. The method according to claim 1, wherein the step of determining whether to display the business object according to the audience attribute information and the business object attribute information comprises:
generating an audience tag vector according to the audience attribute information;
generating a business object tag vector according to the business object attribute information;
determining an activation rate of the business object based on the audience tag vector and the business object tag vector; and
determining, when the activation rate of the business object is greater than a set threshold, to display the business object.

3. The method according to claim 2, wherein the step of generating an audience tag vector according to the audience attribute information comprises:
generating tag values corresponding to audience attributes according to the audience attribute information; and
generating the audience tag vector based on the tag values corresponding to the audience attributes.

4. The method according to claim 2, wherein the step of generating a business object tag vector according to the business object attribute information comprises:
generating tag values corresponding to business object attributes according to the business object attribute information; and
generating the business object tag vector based on the tag values corresponding to the business object attributes.

5. The method according to claim 2, wherein the step of determining an activation rate of the business object based on the audience tag vector and the business object tag vector comprises:
determining the activation rate of the business object based on the audience tag vector and the business object tag vector by means of a logistic regression base model.

6. The method according to claim 2, wherein the step of determining the activation rate of the business object based on the audience tag vector and the business object tag vector comprises:
obtaining an audience weight value and a business object weight value;
weighting the audience tag vector and the business object tag vector respectively based on the audience weight value and the business object weight value; and
determining the activation rate of the business object based on the weighted audience tag vector and business object tag vector.

7. The method according to claim 6, further comprising:
regularizing the activation rate of the business object to obtain an optimal activation rate of the business object.

8. The method according to claim 2, wherein the step of displaying, when determining to display the business object, the business object comprises:
sorting, when it is determined that multiple business objects are displayed, the multiple business objects according to the activation rates of the multiple business objects; and
displaying the business objects in sequential order.

9. The method according to claim 1, wherein the audience attribute information comprises at least one of: basic attributes, physical features, purchase types, short-term attributes, behavior features, psychological features, live broadcast types of videos of interest, real-time state features or video commercial attributes of an audience.

10. The method according to claim 9, wherein the audience attribute information further comprises: followed anchor attribute information; and the followed anchor attribute information comprises at least one of: the talent type of the followed anchor, or the gender ratio and age ratio of a fan group having followed the anchor.

11. The method according to claim 1, wherein the business object attribute information comprises at least one of:
field, brand, effect attributes, trigger information, audience attributes or anchor attributes of the business object.

12. The method according to claim 1, wherein the business object comprises: special effects containing advertising information.

13. An apparatus for recommending a business object, comprising:
a processor;
memory for storing instructions executable by the processor;
wherein the processor is configured to:
obtain audience attribute information and business object attribute information;
determine whether to display the business object according to the audience attribute information and the business object attribute information; and
display, when determining to display the business object, the business object.

14. The apparatus according to claim 13, wherein the processor is configured to:
generate an audience tag vector according to the audience attribute information;
generate a business object tag vector according to the business object attribute information;
determine an activation rate of the business object based on the audience tag vector and the business object tag vector; and
determine, when the activation rate of the business object is greater than a set threshold, to display the business object.

15. The apparatus according to claim 14, wherein the processor is configured to generate tag values corresponding to audience attributes according to the audience attribute information, and generate the audience tag vector based on the tag values corresponding to the audience attributes.

16. The apparatus according to claim 14, wherein the processor is configured to generate tag values corresponding to business object attributes according to the business object attribute information, and generate the business object tag vector based on the tag values corresponding to the business object attributes.

17. The apparatus according to claim 14, wherein processor is configured to determine the activation rate of the business object based on the audience tag vector and the business object tag vector by means of a logistic regression base model.

18. The apparatus according to claim 14, wherein the processor is configured to obtain an audience weight value and a business object weight value, weight the audience tag vector and the business object tag vector respectively based on the audience weight value and the business object weight value, and determine the activation rate of the business object based on the weighted audience tag vector and business object tag vector.

19. The apparatus according to claim 18, wherein the processor is further configured:
regularize the activation rate of the business object to obtain an optimal activation rate of the business object.

20-25. (canceled)

26. A non-transitory computer readable storage medium having stored therein instructions that, when executed by a processor, cause the processor to perform:
obtaining audience attribute information and business object attribute information;
determining whether to display the business object according to the audience attribute information and the business object attribute information; and
displaying, when determining to display the business object, the business object.

27. (canceled)
